(19) United States
(12) Patent Application Publication
(10) Pub. No.: US 2012/0303211 A1
(43) Pub. Date: Nov. 29, 2012

(54) Safety evacuation system for drivers and passengers of ground and water vehicles

(76) Inventor: Igor Igorevich Stukanov, Toronto (CA)

(21) Appl. No.: 13/134,050

(22) Filed: May 27, 2011

(51) Int. Cl. G06F 19/00; G08G 3/02; B60R 21/16; G08G 1/16

(52) U.S. Cl. 701/36; 701/301; 280/728.1

(57) ABSTRACT

A safety evacuation system for drivers and passengers of ground and water vehicles is proposed. The system is comprised of a sensor system, computer implemented model of risk assessments from collisions with surrounding objects, control system, safety escape channels, and ejection seats. The sensor system measures directions, speeds and distances of a vehicle to all objects, which may collide with the vehicle and pose risk of deaths or injures to humans in the vehicle. The computer-implemented model assesses the risk of deaths and injuries for humans, based on the measurements of the sensor system. The control system opens the escape channel and activates ejection seats based on the risk assessments from the computer-implemented model.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention relates to systems for preventing deaths or life threatening injuries of drivers and passengers of ground and water vehicles, such as cars, boats, etc. from collisions or other accidents.

2. Background Information

More than 1 million people are killed in car accidents worldwide and over 10 millions are injured. The direct costs exceed $500 billions of USD and the indirect costs are estimated in trillions of USD.

The available currently systems based on air bags, seat belts and intelligent car control systems are useful only in cases when people are exposed to low energy forces and pressures, for example in collisions with speeds below 65 km/h. Such systems often will not save humans from death or injuries in cases of high-energy crashes, for example high-speed collisions on highways.

### BRIEF SUMMARY OF THE INVENTION

The present invention is a system, which purpose is to address the problem of how to reduce the numbers of human deaths and injuries from car incidents by over 90% in high energy crashes, for example high-speed collisions on highways. The system is comprised of a sensor system, computer implemented model of risk assessments from collisions with some objects, control system, safety escape channels, and ejection seats. The sensor system measures directions, relative speeds and distances of a vehicle to all objects, which may collide with the vehicle and pose risk of deaths or injures to humans in the vehicle. The computer-implemented model assesses the risk of deaths and injuries for humans, based on the measurements from the sensor system. The control system opens the escape channels and activates ejection seats based on the risk assessments from the computer-implemented model.

### BRIEF DESCRIPTION OF THE SEVERAL VIEWS OF THE DRAWINGS

FIG. 1. A structural scheme of the system.

FIG. 2. Activation of the ejection seat before a collision of cars.

FIG. 3. Landing of the ejection seat.

FIG. 4. Activation of the ejection seat before a hit by an anti tank missile.

FIG. 5. Activation of the ejection seat before a collision of boats.

### DETAILED DESCRIPTION OF THE INVENTION

Structure

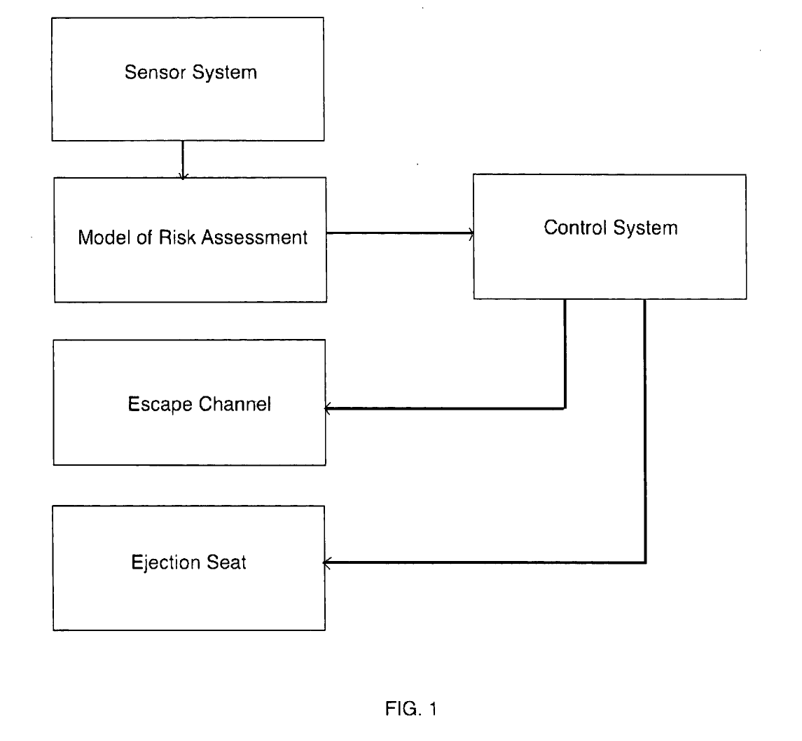

FIG. 1 shows all components of the invention with relations among them.

The components are:
a sensor system;
a computer implemented model of risk assessments (deaths or serious injuries of humans);
a control system;
an escape channel;
an ejection seat.

The novelty of this invention consists in the unobvious combination of well-known components, which produces useful and unexpected results. All components of the proposed invention are well known in the prior art and are used over many decades in corresponding industries. Some references are below:
Introduction to Sensor Systems (Artech House Communication and Electronic Defense Library) by Shahen A. Hovanessian (Oct. 1, 1988)
Sensors and Control Systems in Manufacturing, Second Edition by Sabrie Soloman (Nov. 2, 2009)
Intelligent Sensor Systems, (Sensors Series) by John Brignell and Neil White (Jan. 1, 1996)
Handbook of Modern Sensors: Physics, Designs, and Applications by Jacob Fraden (Sep. 29, 2010)
Introduction to Radar Systems by Merrill Ivan Skolnik (Dec. 20, 2002)
Risk Modeling, Assessment, and Management (Wiley Series in Systems Engineering and Management) Yacov Y. Haimes
Probabilistic Risk Analysis: Foundations and Methods by Tim Bedford and Roger Cooke (Apr. 30, 2001)
Risk Assessment And Decision Making In Business And Industry: A Practical Guide—Second Edition by Glenn R. Koller (Mar. 30, 2005)
Automatic Control Systems by Farid Golnaraghi and Benjamin C. Kuo (Jul. 7, 2009)
Development of catapult aircraft ejection seat XM10 (FA report) by H. D MacDonald (1961)
Ejection seat by Frederic P. Miller, Agnes F. Vandome and John McBrewster (Feb. 19, 2011)

Operation

The sensor system measures directions, distances and relative speeds to surrounding objects and passes this info to the computer-implemented model of risk assessments. The computer-implemented model of risk assessments evaluates the risks of deaths or serious injuries to humans and sends these evaluations to the control system. The control system opens the escape channels in the case of the risk is close to a critical value and activates the ejection seats in the case of the risk is equal or greater than the critical value.

The examples below give more specific implementations of the current invention.

### EXAMPLE 1

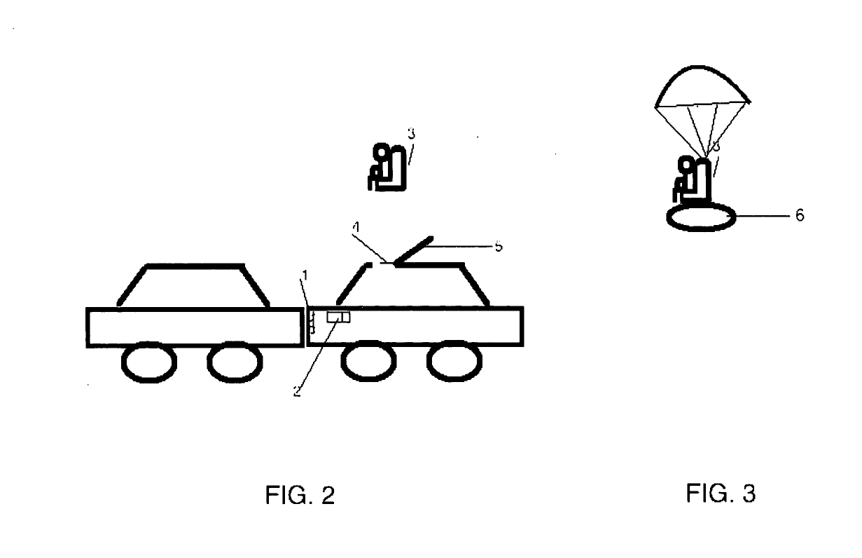

In this example, the system for a passenger car is described (FIGS. 2,3). The sensor system (1, FIG. 2) is a radar-based system, which measures directions, distances and relative speeds to surrounding objects. Based on these measurements, the computer-implemented model of risk assessments calculates a probability of a death or life threatening injuries from a collision or an accident with one or several surrounding objects. The probability is calculated as a ratio of Nd/Nt, where Nt is a total number of cases with such conditions and Nd is a number of cases with such conditions in which serious injury or death was followed. If this probability is over 0.97 but less than 0.99 then the control system opens the escape channel (4, FIG. 2) by opening a cover (5, FIG. 2) of the escape channel. The control system and the model are shown in block 2 of FIG. 2. If this probability is equal or greater than a critical value of 0.99 then the control system activates the ejection seat (3, FIG. 2). The ejection seat is propelled into the space by a compressed air and is directed by a navigation system of the ejection seat in a safe direction. Before a landing of the ejection seat, the navigation system activates an air bag (6, FIG. 3) to cushion the landing as shown on the FIG. 3.

### EXAMPLE 2

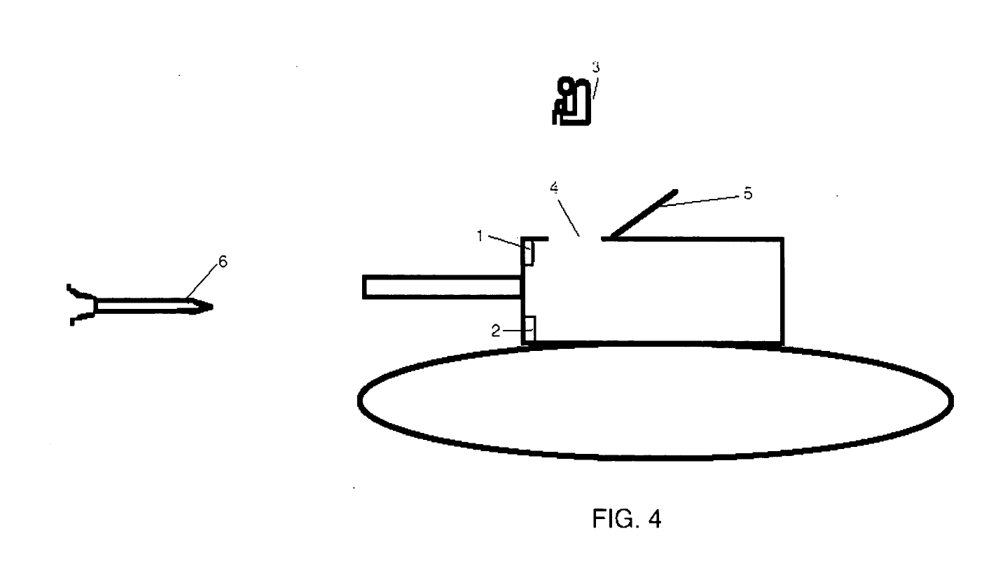

In this example, the system for a military tank is described as shown on FIG. 4. The sensor system consists of multiple sub-systems of radar, lidar and laser scanners, which measure directions, distances, masses, types and speeds of surrounding objects. Based on these measurements the computer-implemented model of risk assessments calculates probabilities of a hit or collision with these objects and force of impact on humans from the hit or collision. If this force may cause a death or life threatening injuries from a hit by an anti-tank missile and the probability is over 0.95 but less than 0.97 then the control system opens the escape channel by opening the cover of the escape channel. If this force may cause a death or life threatening injuries from a hit by an anti-tank missile and the probability is equal or greater than a critical value of 0.97 then the control system activates the ejection seat. The ejection seat is propelled into the space by a rocket motor and is directed by a navigation system of the ejection seat in a safe direction.

### EXAMPLE 3

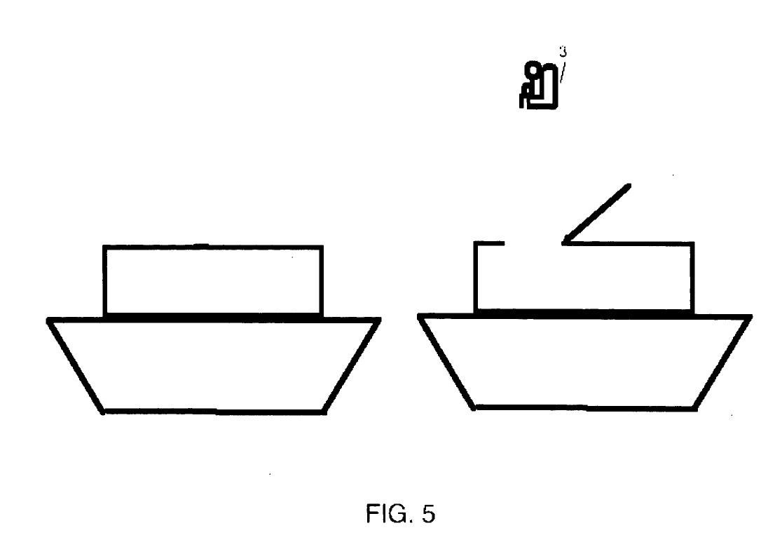

In this example, the system for a boat is described as shown on FIG. 5. This system is similar to the system described in the Example 1, except the moving vehicle is a boat instead of a car.

1. A system for safety escape of a driver and passengers of a ground vehicle comprising of the following parts:
(1) a sensor system, which measure speeds and distances of the vehicle relative to other objects near the vehicle, directions and speeds of these objects;
(2) a computer implemented model, which assesses risks to life of the driver and passengers from collisions or other incidents, based on the measurements of said sensor system;
(3) a control system, which gets the risk assessments from said computer implemented model and activates some components of this system based on levels of said risk assessments;
(4) escape channels, opened by said control system and via which the driver and passengers escape in the case of high risk of a collision or an incident;
(5) ejection seats, which are propelled out of the vehicle with a driver and passengers via said escape channels into the space in a safe direction upon activation by said control system.

2. A system as in claim 1, wherein the vehicle is a vehicle moving on water.

3. A system as in claim 1, wherein said sensor system is a radar based system.

4. A system as in claim 1, wherein said sensor system is a lidar based system.

5. A system as in claim 1, wherein said sensor system is a laser scanner based system.

6. A system as in claim 1, wherein said ejection seats are equipped with a navigation system to direct the seat in the direction of the lowest risk to a human.

7. A system as in claim 1, wherein said ejection seat is equipped with an air bag cushion to mitigate landing of the seat with a human.

8. A system as in claim 1, wherein said sensor system measures only directions, distances, and speeds of surrounding objects.

9. A system as in claim 1, wherein said sensor system estimates other properties of surrounding objects.

10. A system as in claim 1, wherein said computer implemented model uses one-dimensional metrics for risk assessments.

11. A system as in claim 1, wherein said computer implemented model uses multi-dimensional metrics for risk assessments.
